(19) United States
(12) Patent Application Publication
(10) Pub. No.: US 2015/0227880 A1
(43) Pub. Date: Aug. 13, 2015

(54) Vehicle Repair Software Application

(71) Applicant: Edwich Pierrelouis, Edison, NJ (US)

(72) Inventor: Edwich Pierrelouis, Edison, NJ (US)

(21) Appl. No.: 14/179,551

(22) Filed: Feb. 12, 2014

(51) Int. Cl. G06Q 10/06; H04W 4/12; G06Q 10/10

(52) U.S. Cl. CPC G06Q 10/063114; G06Q 10/1095; H04W 4/12

(57) ABSTRACT

A module of a software application that allows customers to schedule service appointments for their vehicle, so that when the customer brings his vehicle into a vehicle repair shop or dealership, the dealer can register the customer's vehicle into a software database to allow the dealer to chat with the customer and send media (pictures, video, sound). The dealer can also alert the customer of the status of the vehicle's repair progress. The customer can see a status bar indicating the progress of his vehicle service and the expected completion time of the repairs. There is also an option to pay for the vehicle repair service through the VSM feature.

### CROSS-REFERENCE TO RELATED APPLICATION

This application claims the benefit of the priority filing date of provisional patent application No. 61763936 filed on Feb. 12, 2013.

### FEDERALLY SPONSORED RESEARCH

Not Applicable

### SEQUENCE LISTING OR PROGRAM

Not Applicable

### BACKGROUND

The invention relates to a module of a software application that allows customers to schedule service appointments for their vehicle via their mobile phones and to interact with repair shop personnel, wherein a vehicle is registered into a database when a customer seeks repair of his vehicle, the repair shop personnel can interact with the customer electronically through a software application. Features include chatting, sending visual and audio media, sending status and progress reports, and estimated completion times, and payment options.

Currently, persons who bring their vehicle to a vehicle service station or a repair shop must wait for their vehicle for at least one working day. Customers do not know whether the vehicle could be fully serviced within the same working day, and if so, at what hour. As such, customers are forced to keep calling the vehicle repair shop for a status report. This causes repair shop personnel to field a lot of calls throughout the day. Not only do the calls disrupt the personnel's work, it also causes uncertainty and inconvenience for a customer trying to plan their daily schedule.

Furthermore, with reports of mechanics not performing the needed repairs, or performing unneeded repairs, a system of accountability is needed to show a customer what work needs to be done, the progress of that work, and evidence of the work.

A need arises for a more efficient way for a customer and vehicle repair shop personnel to communicate with each other via mobile phones, to display chat communication, show real time images, and to display progress reports and estimated completion times. The need is satisfied in the form of a module of a software application of the present invention.

### SUMMARY

A module of a software application that allows customers to schedule service appointments for their vehicle, so that when the customer brings his vehicle into a vehicle repair shop or dealership, the dealer can register the customer's vehicle into a software database to allow the dealer to chat with the customer and send media (pictures, video, sound). The dealer can also alert the customer of the status of the vehicle's repair progress. The customer can see a status bar indicating the progress of his vehicle service and the expected completion time of the repairs. There is also an option to pay for the vehicle repair service through the VSM feature.

### DRAWINGS

The invention can be further demonstrated by way of the following drawings:

FIG. 1A: Appointment Screen on the world wide web

FIG. 1B: Appointment screen on a mobile software application

FIG. 2A: Drop-off screen on the world wide web

FIG. 2B: Messaging screen on a mobile software application

FIG. 3A: Status Screen on the world wide web

FIG. 3B: Status Screen on a mobile software application

FIG. 4A: Payment Request Screen on the world wide web

FIG. 4B: Payment Request Screen on a mobile software application

FIG. 5A: Completion Screen on the world wide web

FIG. 5B: Completion Screen on a mobile software application

### REFERENCE NUMBERS

100 inventive software

101 mobile application

102 appointment screen

102A appointment screen on a mobile application

104A repair shop schedules appointments

104B customer schedules appointments

106 register a vehicle by VIN

108 input customer details

110A repair shop message center

110B customer message center

112 repair service items

114A customer inputs details about vehicle

114B repair shop inputs details about vehicle

116A customer upload images on the mobile application

116B repair shop personnel upload images

118 repair shop drop off screen

120 status tool bar

### DETAILED DESCRIPTION

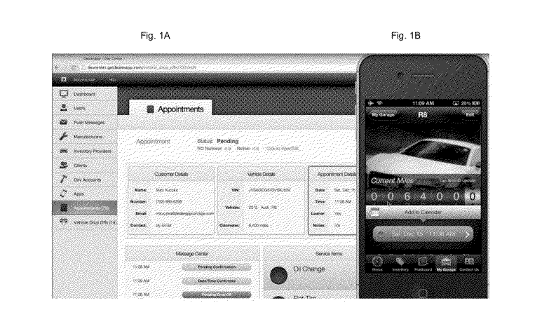

FIG. 1A is the appointment screen (102) of the inventive software (100) from the point of view of repair shop personnel viewing the appointment screen. The software is operable to allow repair shop personnel to set appointments (104) with a customer, register a vehicle by Vehicle Identification Number (VIN) (106), input customer details (108), send messages or chat with the customer through a message center (110), and indicate various repair service items (112), including oil change, flat tire, air filter problems, and services based on mileage.

FIG. 1B is the appointment screen from the point of view of the customer viewing the appointment screen (102A) on a mobile application (101). The customer may input details about the vehicle (114A), including mileage, upload visual images (116A) on the mobile application, and schedule an appointment (104B).

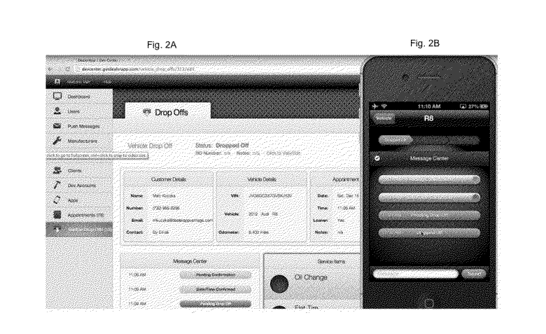

FIG. 2A features a repair shop drop-off screen (118) for repair shop personnel to use, indicating when the vehicle was dropped off at the repair shop. Details about the status of the vehicle are entered into the repair message center (110A), which the customer sees, in FIG. 2B, in the customer message center (110B) through the mobile application. Repair shop personnel may input further details about the vehicle (114B), including make and model.

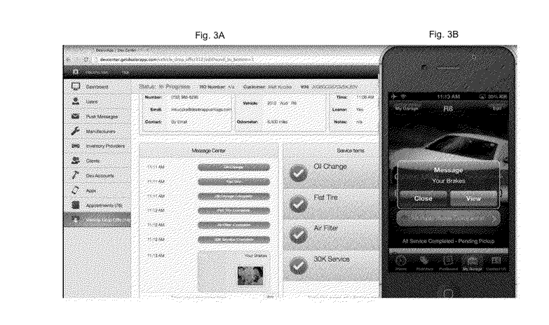

FIGS. 3A and 3B illustrate status screens once the vehicle has been dropped off. A status toolbar (120) indicates the status of the work to be performed, as well as information about the owner and vehicle. FIG. 3A illustrates a feature in which repair shop personnel may upload images (116B) through the repair shop message center (110A). Simultaneously, as seen in FIG. 3B, the customer receives the image along with messages in the customer's message center (110B). Furthermore, repair service items (112) are check marked by the repair service personnel as work is completed. In this way, repair shop personnel can explain to the customer work to be performed, as well as work already performed, in real time. The message center therefore acts as a means for conveying a progress report.

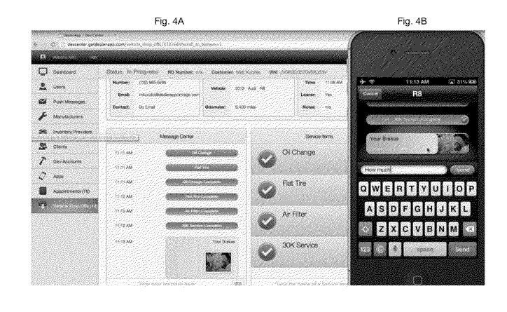

FIG. 4A illustrates the final stages of the work performed, at which point, repair shop personnel may request payment for work performed. Payment details may be conveyed through the message screen, indicating how the customer may make payment. FIG. 4B illustrates how the customer may make payment arrangements with the vehicle repair shop, using the message center.

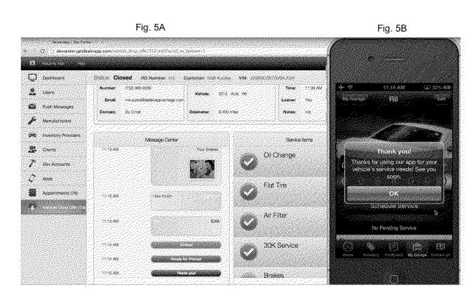

FIGS. 5A and 5B illustrates completion screens. FIG. 5A shows the status on the status toolbar (120) as “closed.” All repair service items (112) that were performed are check-marked, and the repair shop personnel can confirm payment via the repair shop message center (110A), whereupon closing of the matter results in a final Thank you message (122) to the customer.

What is claimed:

1. A computer-readable, non-transitory medium storing therein a control program that causes a computer to execute a procedure, the procedure comprising the following steps:
Details about a vehicle are input into a computer database via software viewable over the world wide web and a mobile application;
A date for repairs is scheduled in said computer database, via said software and mobile application, and are viewable under an appointment screen of said software and mobile application;
Details about the status of the vehicle are input into said computer database via said software when the vehicle is dropped off at a repair shop, said details being simultaneously viewable in said mobile application;
Status information is input into the computer database, via said software and mobile application, said status information being viewable via both software and mobile application, and includes status of work performed, nature of the work performed, and video and audio media relating to the work performed, wherein inputting of said status information includes text messaging, chatting, and uploading image and audio files; and
Completion details are input into the computer database via said software and mobile application, said completion details being viewable via both software and mobile application, including final status of work performed, nature of work performed, costs, and method of payment, wherein inputting of said completion details includes text messaging, chatting, and uploading image and audio files.
